(19) United States
(12) Patent Application Publication
(10) Pub. No.: US 2009/0012827 A1
(43) Pub. Date: Jan. 8, 2009

(54) Methods and Systems for Analyzing Patent Applications to Identify Undervalued Stocks

(76) Inventor: Adam Avrunin, Cary, NC (US)

Correspondence Address: ADAM AVRUNIN, 4921 BERRY ROSE WAY, CARY, NC, 27518, US

(21) Appl. No.: 11/773,464

(22) Filed: Jul. 5, 2007

(51) Int. Cl. G06F 9/44; G06Q 40/00

(52) U.S. Cl. 705/7; 705/36 R

(57) ABSTRACT

The present invention relates to predicting the value of a published patent application prior to its issuance as a patent. Once a patent application publishes, as most U.S. applications do eighteen months after filing, one can identify the patents cited against the patent application during its prosecution. Such patents may be cited by the applicant in an Information Disclosure Statement (IDS) and/or by the Examiner assigned by the Government to examine the patentability of the application. In some embodiments, the cited patents are evaluated by comparing how frequently they are cited relative to other patents that issued in the same year and in the same technology class. If the cited patents are frequently cited relative to their peers, then the subject patent application likely covers significant technology and has value. The present invention may have several implementations. For example, the present invention may simply be embodied as a service that provides metrics for or reports on the value of various patent applications. In other embodiments, the method for evaluating the value of a single patent application is extended to each of the patent applications in a patent portfolio so as to render judgment on the value of the entire application portfolio. In turn, one can use the value of all or part of the patent-application portfolio to help identify stocks of undervalued companies.

### DESCRIPTION OF THE INVENTION

1. Field of the Invention

The present invention relates to a data-processing system that analyzes intellectual-property information.

2. Background of the Invention

High technology companies engage in intense research and vigilant protection of intellectual property to maintain their market leadership. One of the leading forms of intellectual property is a U.S. patent, which provides the patent's owner the right to exclude others from making, using, selling, offering for sale, and importing the invention claimed in the patent for a limited period of time. Accordingly, a company's patent portfolio and the technological advances represented by those patents can have a dramatic effect on that company's success in the market.

People have previously analyzed the number of citations to a company's issued patent to determine the value of the technology protected by that patent. In particular, citations to a patent indicate that an applicant or Government agency considers that patent's technology to have relevancy to technological advancements claimed in later patent applications, so the number of citations to a patent serves as a proxy for determining the importance and fundamental nature of the technology underlying that patent.

One way to perform a citation analysis on a patent is to compare the number of citations to the company's issued patent to the number of citations to other patents that were issued in the same year and in the same technology class as the company's patent. A patent that is cited more frequently than its peers that issued in the same year and in the same technology class likely covers more significant technology.

Unfortunately, patents take a long time to issue. It takes even longer for a meaningful number of other patents to start citing an issued patent. This renders classic patent-citation analysis of little value in making investment decisions about high technology companies. By the time enough relevant citation data can be collected for a given issued patent, the technological advance represented by that patent has already been factored into the stock price of the company owning that patent, as the company will likely have long had products on the market that incorporate the technological advance.

Accordingly, it would be desirable to measure patent significance at an earlier stage than what typical patent-citation analysis can achieve.

### BRIEF DESCRIPTION OF THE DRAWINGS

The accompanying drawings, which are incorporated in and constitute a part of this specification, illustrate embodiments of the invention. Together with the description, they serve to explain the principles of the invention. Following is a brief description of the drawings:

FIG. 1 illustrates an exemplary system of the present invention.

FIG. 2 is a logical flow diagram of a method for analyzing the significance of a patent application based on the patents cited against it during prosecution in accordance with an exemplary embodiment of the present invention.

FIG. 3 is a logical flow diagram of a method for analyzing the significance of a portfolio or set of patent applications in accordance with an exemplary embodiment of the present invention.

FIG. 4 is a logical flow diagram illustrating a method for recommending stocks of one or more companies by analyzing their patent applications in accordance with an exemplary embodiment of the present invention.

### DESCRIPTION OF A FEW EMBODIMENTS OF THE INVENTION

The present invention relates to predicting the value of a patent application, regardless of whether or not it has yet matured into an issued patent. To understand how this process works, one may benefit from some background information about how governments make information about filed patent applications available to the public.

In many jurisdictions, the government publishes a patent application prior to its issuance as a patent. For example, in the United States, the U.S. Patent & Trademark Office (“PTO”) publishes most patent applications about eighteen months after filing, even though it typically takes longer than that for a patent application to mature into an issued patent.

Once a patent application publishes in the United States, one can identify the patents cited against the patent application during its prosecution. Such patents may be cited by the applicant in an Information Disclosure Statement (“IDS”) and/or by the Examiner assigned by the Government to examine the patentability of the invention covered by the application. An interested party can easily obtain this data through the information systems of the PTO, such as its public Patent Application Information Retrieval (“PAIR”) system, which makes available to the public in electronic format the papers forming the prosecution history of a published patent application.

In some embodiments of the present invention, the value of a published patent application is evaluated based on the patents cited against it. The cited patents may be evaluated by comparing how frequently they are cited relative to their peer patents—i.e., those patents that issued in the same year and in the same technology class. Alternatively, other kinds of citation metrics known to those skilled in the art can be used as a proxy for determining that the cited patents cover important technology. If at least some of the cited patents are frequently cited relative to their peers (or the citation metrics used for the cited patents suggest that the cited patents cover important technology), then the subject patent application against which these patents have been cited likely covers significant technology and has value.

Here is the underlying rationale for this method. If the patents cited against a patent application are highly cited by yet other patents, then these cited patents probably represent important technology themselves. At the same time, the cited patents are theoretically the closest prior art to the patent application against which they are cited, and the patent application should result in an issued patent only if it represents an advance over this prior art. In other words, a patent application having cited patents that themselves have a high number of citations suggests that the patent application represents an advance over important technology.

The valuation of a patent application may be based on assessing one or more of the patents cited against it during its prosecution. The importance attached to a given cited patent may be weighted differently depending on whether that cited patent was identified by the Examiner (in an Office Action, for example) or by the applicant (in an IDS, for example). Embodiments of the present invention may examine only those patents cited by an Examiner, only those cited by the applicant, or some combination of such patents. Significance may optionally be attached to how many or what percentage of the cited patents are highly cited by yet other patents, as well as how frequently they are cited.

The present invention may have several implementations. For example, the present invention may simply be embodied as a service that provides metrics for various patent applications or reports on the value of various patent applications. In other embodiments, the method for evaluating the value of a single patent application is extended to multiple patent applications in a set or portfolio of patent applications so as to render judgment on the value of the entire set or portfolio.

In turn, one can use the value of all or part of the patent-application portfolio to help identify stocks of undervalued companies. Specifically, if this method of analyzing a company's patent applications indicates that the company's patent applications are valuable, then the company or its stock may be undervalued. That is because the company owning a patent application often has not yet had time to commercialize—and the market has therefore not yet recognized the importance of—the technological advances represented by the company's patent applications. The present invention may thus be useful in identifying the value of a company's underlying technology before the market or other methods of analysis recognize this value.

Once undervalued stocks have been identified by this method of analyzing patent applications, a stock recommendation service based on the analysis methods of the present invention could recommend such stocks to subscribers to the service. Alternatively, a mutual fund or other financial instrument could invest in such stocks, using the patent-application analysis of the present invention as the basis for its investment strategy.

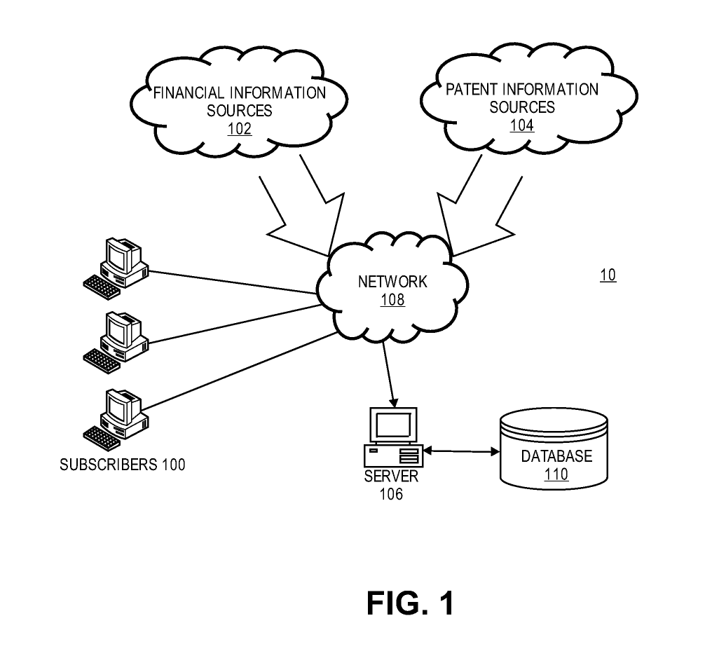

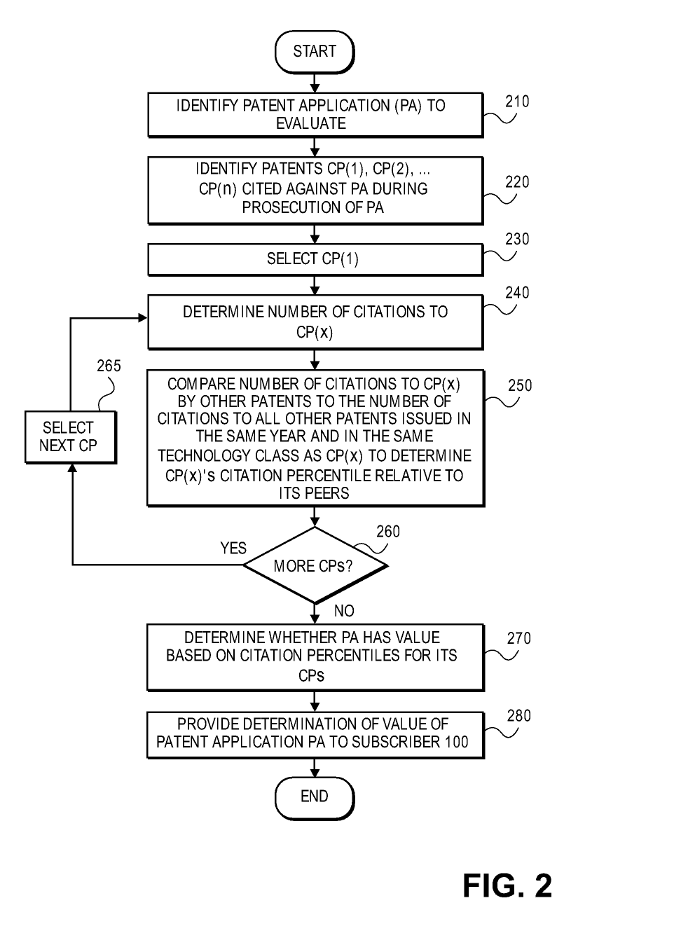

Reference will now be made to exemplary embodiments of the invention, which are illustrated in the accompanying drawings. FIG. 1 illustrates an exemplary system of the present invention. FIGS. 2-4 are logical flow diagrams illustrating process flows for exemplary embodiments of the present invention. Wherever possible, the various drawings use the same reference numbers to refer to the same or like parts.

FIG. 1 is an exemplary system consistent with the present invention. As shown, a system 10 may include subscribers 100, financial information sources 102, patent information sources 104, a server 106, and perhaps a database 110 accessible by the server 106. These components may be coupled across a network 108. Network 108 may comprise a local area network, a wide area network, the Internet, and/or the like. Each of the components of system 10 will now be briefly described.

Subscribers 100 generally illustrate users and client devices of system 10. These users and client devices may employ well known devices, such as personal computers, mobile phones, laptop computers, and the like to access the services of system 10, which are usually provided by software running on server 106. One skilled in the art will recognize that any sort of processing device may utilize the services of server 106 and system 10.

Financial information sources 102 may include any database or source providing information about publicly traded companies. For example, information sources 102 may comprise information about companies listed on the New York Stock Exchange (“NYSE”) or the NASDAQ stock exchange. Information sources 102 may also comprise information such as company Web sites, online annual reports, Moody's Investor Services, the EDGAR service provided by the Securities and Exchange Commission, and so on.

While the financial information sources 102 discussed above provide information about publicly traded companies, those skilled in the art will recognize that the methods of the present invention may also be used to evaluate the patent applications of privately held companies. Such evaluations of those patent applications may, in turn, be used to inform decisions about investing in privately held companies. In such embodiments, the financial information sources 102 would include information about such privately held companies. Patent information sources 104 include any database or source that can provide patent-application information. For example, the Web site and services of the U.S. Patent and Trademark office at www.uspto.gov and/or the patent search engine provided by Google can both provide information about U.S. patents and patent applications.

For the sake of brevity, the present disclosure describes embodiments that pertain to analyzing the value of U.S. patent applications. But one skilled in the art will recognize that the present invention can be easily extended to analyzing the value of foreign patent applications filed in foreign patent systems, as well as analyzing the value of other forms of intellectual property throughout the world. To extend the present invention to foreign patent applications, different resources known to patent practitioners can be consulted to obtain relevant information about such applications.

In some embodiments of the present invention, information needed to analyze the value of U.S. patent applications is obtained through the U.S. PTO's public PAIR service. This well known service is available over the Internet and allows for public access to the prosecution-history documents and transactions for published patent applications.

Server 106 comprises the software and hardware to execute the algorithms of the present invention. Software implementing the algorithms of the present inventions may run on hardware and software of the kind typically used for servers, such as server 106. For example, server 106 may comprise software for a web server, an application server, a database server, and so on.

Server 106 may be coupled to a database 110 that tracks and manages the financial and patent information about the various companies being evaluated. Using database 110 and the patent-application information from patent information sources 104, server 106 may evaluate a patent application of a company by assessing one or more of the patents cited against it during its prosecution. In some embodiments, server 106 implements algorithms that assume that patent applications are valuable if the patents cited during their prosecution against them are themselves frequently cited by other patents. Server 106 may ascribe different levels of importance to the cited patents based on how frequently a given cited patent is itself cited by other patents, as well as whether that cited patent was identified by the Examiner (in an Office Action, for example) or by the applicant (in an IDS, for example).

The server 106 may perform similar analyses of multiple patent applications owned by the same company. Additionally, server 106 may use the foregoing analysis of one or more (or all) of a company's patent applications to inform a recommendation about investing in a company or the stock of that company, using the assumption that patent applications recognized as valuable according to the methods of the present invention typically represent technological advances that have not yet been commercialized or appreciated by the market.

In providing investment advice about a company or multiple companies, the server 106 may use this analysis of the company's patent applications as but one factor. Server 106 may also incorporate other factors, such as traditional investment metrics known to those skilled in the art of investing. The information for such traditional investment metrics may come from financial information sources 102.

Server 106 may provide different services to subscribers 100 based on their subscriptions or requests for information. For example, for a given patent application, server 106 may simply provide metrics regarding the citation frequency of patents cited against that patent application. Alternatively, the server 106 may interpret this data about a patent application and use this data to provide an indication of the value of the patent application.

Used in this context, the term “value” is not limited to providing a monetary assessment about the worth of a patent application. Rather, “value” may alternatively refer to a descriptive assessment of the patent application, such as “valuable” or “not valuable” or “of questionable value.” “Value” may also refer to a relative determination of value, indicating that one patent application is more valuable than a second patent application, such as because the patents cited against it are more frequently cited by other patents than the patents cited against the second application.

Subscribers 100 may also be subscribers to a stock recommendation service. In this embodiment, the server 106 recommends stocks of companies to the subscribers based at least in part on the server's determination that the companies whose stock it recommends have one or more valuable patent applications. The server 106 may also compare the patent applications of two or more companies, recommending the stock in the company whose patent applications have more value. In addition to evaluating patent applications to make stock recommendations, the server 106 may also factor in traditional investment metrics known to those skilled in the art of investing in recommending or comparing stocks. Alternatively, server 106 may employ this patent-application analysis as part of an investment algorithm for a mutual fund or other financial instrument.

In general, database 110 serves as a storage location for the patent information collected by server 106 and financial information (including historical stock prices) from financial information services 102 for the companies that own the patent applications to be analyzed. If needed, server 106 may be configured to collect data on only those companies with a sufficient number of patents or patent applications. For example, server 106 may focus its algorithms on companies that have at least twenty pending but published patent applications.

Database 110 may also comprise various data structures and tables to accurately track when a common owner has control over patent applications that have different assignee names. For example, the database 110 may track when companies are related, such as by being in a parent-subsidiary relationship or being sister companies of each other (i.e., two companies owned by the same parent). Additionally, it is known by those skilled in the art that a company may employ various assignee names or acquire the rights to patent applications assigned to other companies. Accordingly, database 110 may include information that links assignee names to an ultimate parent company. This information can be obtained by collecting information from financial information sources 102. For example, linked assignee names can be discovered by consulting company Web sites, annual reports, Dun and Bradstreet reports, Who-Owns-Whom (published by the Directory of Corporate Affiliations™), and/or the like to discover parent-subsidiary relationships or other relationships between companies. Tracking patent applications that are linked to a common ultimate owner is especially useful in those embodiments of the present invention where patent-application analysis informs an investment decision in that common ultimate owner.

In addition, database 110 may enable subscribers 100 to instruct server 106 to analyze, using the patent-application analysis methods of the present invention, investment decisions in all companies that meet specified criteria, such as being in a given industry (e.g., Automotive, Software, Telecommunications, Chemical, Pharmaceutical, etc.), having a specified size (e.g., number of employees, market capitalization, enterprise value, revenue), and the like. The database 110 may do this by obtaining such information about companies from financial information sources 102 and then storing such information in searchable data structures.

Database 110 may also store information obtained from patent information sources 104 that indicates the patent applications for each of the companies, enabling the server 106 to analyze the patent applications of selected companies and make investment recommendations in those companies based on such analysis. For example, a subscriber 100 may request investment recommendations for stocks in all software companies with a market capitalization greater than $4 billion. The server 106 would then determine the universe of relevant companies by consulting database 110, analyze the patent applications of those companies (again consulting database 110 to identify the applications to be analyzed for each company), and based on such analysis, recommend stocks in those companies whose patent applications were determined to be valuable enough. Server 106 may also perhaps provide a comparative assessment of the value of the various stocks.

Before turning to the process for evaluating the significance of a patent application according to the methods of the present invention, some background on patent prosecution and traditional citation analysis is provided. In general, patent prosecution is the process by which the Government determines whether a patent application meets the legal requirements for issuance as a patent.

The patent prosecution process begins when a patent application is filed in the U.S. PTO. Patent applications are typically kept confidential by the PTO until about eighteen months after filing, at which point most U.S. patent applications publish. At this point, the public can learn about the application, such as by searching for published patent applications at the U.S. PTO's Web site.

Following publication, the public also can inspect the prosecution proceedings for the patent application. One way to do this is through the PTO's public PAIR system, which makes the prosecution history of a published patent application available electronically to users of the PTO's Web site.

During the prosecution process, the applicant cites prior art of which he is aware (in one or more IDS's), and the Examiner cites relevant patents that he discovers in his search and examination of the patentability of the invention disclosed in the application. The Examiner has a duty to grant patents only on technology that is new and nonobvious over what came before—the so-called prior art. So the applicant and the Examiner will typically debate the relevancy of these cited patents and other prior art to determine the scope of what the patent should cover so that it represents an advance over the prior art. If they can agree on this scope, then the patent application is permitted to issue as a patent.

Depending on the technology class to which the patent application is directed, a patent application may be pending in its prosecution process for three to four years or more after the filing date of the application because of the backlog of applications that the PTO has to examine. When the patent issues, the patents and publications that were cited against it during prosecution are listed on the cover page of the patent as cited references.

Those skilled in the art may be familiar with traditional patent-citation analysis. Such analysis uses the number of citations to an issued patent by other patents as a proxy for the importance or significance of the patent. The higher the number of citations, the more important the patent is assumed to be. One should note that the longer an issued patent has been around, the more opportunity there is for it to be cited on the covers of later-issued patents. Thus, over time, a patent may accumulate citations from other patents as its significance is recognized.

One problem with traditional patent-citation analysis is that it does not provide a meaningful indication of the value of the underlying technology until many years after the filing date of the relevant application. That is because a patent may not issue from a patent application until three to four years or more after the filing date of that application, and then it may be several more years before enough later issued patents have time to cite that patent so that the citation data for that patent is meaningful. By that time, the underlying technology has typically long been commercialized, and the value of the underlying technology has long been priced into the stock of the company that developed it. For this reason, traditional citation analysis does not provide particularly useful or timely information for making decisions about investing in the stock of the company that owns the patent. Accordingly, through the use of FIGS. 2-4, several embodiments of the present invention will now be described that provide a novel way of anticipating the significance of a patent application at an early stage in its prosecution and before it matures into a patent.

FIG. 2 presents a logical flow diagram of an inventive method that enables analyzing the significance of a patent application at a much earlier stage. This enables one to evaluate the significance of a patent application long before its issuance as a patent, if desired. Briefly, the theory behind this method is that a patent application is significant if the patents that were cited against it during prosecution are relatively highly cited. This is because the patent application should issue as a patent only if it represents a technological advance over the patents that were cited against it. So if the cited patents are themselves highly cited, then the patent application itself represents an advance over important technology.

The method disclosed in FIG. 2 starts at step 210. In step 210, the server 106 identifies a patent application “PA” to evaluate. The decision of the server 106 to evaluate a particular application PA may be based on instructions from one of the subscribers 100 making a query about the value of patent application PA. Alternatively, the server 106 may be evaluating the value of a group of patent applications and evaluate each one in turn according to the method disclosed in FIG. 2.

Once a patent application has been selected for evaluation, the evaluation process begins in step 220. In step 220, the server 106 identifies the n patents (n>=1) that have been cited against the patent application PA during the prosecution of PA. For convenience of explanation, these n cited patents will be denoted CP(1), CP(2), . . . CP(n). The cited patents CP(1), CP(2), . . . CP(n) may be identified by reviewing the prosecution records, such as any IDS's and Office Actions, for the patent application. Such records are available, for example, through the U.S. PTO's public PAIR system. Alternatively, the cited patents CP(1) . . . CP(n) may be identified through other resources known to those skilled in the art. The cited patents CP(1) through CP(n) selected for further evaluation may be only those cited by the applicant against PA, only those cited by the Examiner against PA, or some combination or all of these patents.

Each of the cited patents CP, with a given patent denoted generically as CP(x), is now evaluated in turn by server 106. In step 230, the first of the cited patents, CP(1), is selected for processing by server 106.

In step 240, the server 106 determines the number of citations to CP(x) by other patents. As noted, this means that CP(x) was cited against those patents during prosecution of those patents, then listed on their cover pages after they issued. Such information may be readily available to server 106 by querying patent information sources 104 or its database 110.

In step 250, the server 106 identifies those patents that issued in the same year and the same technology class as CP(x). These patents may be referred to as “peers” of CP(x). The server 106 then compares the number of citations to CP(x) by other patents to the number of citations to CP(x)'s peer patents. Server 106 does this to arrive at a citation percentile for CP(x) that indicates the percentage of CP(x)'s peers that have fewer citations than CP(x). Thus, the higher the citation percentile for CP(x), the more highly cited CP(x) is relative to its peers, and under classic citation analysis, the more valuable the technology claimed in CP(x) likely is.

One reason for determining a citation percentile for CP(x) relative to its peers is to normalize the number of citations to CP(x). Typically, the number of citations to a patent increases with age, as newer patents have an opportunity to cite the previously issued patent. Also, some types of technologies tend to build on multiple older technologies more so than other types of technologies, so patents of the same age but directed to two different technologies may accumulate different numbers of citations, even though both patents may be equally valuable. The normalization process described in step 250 is one example of a scheme that factors out these two variables of age and technology class of the patents so that comparisons between citations to the various CP's are meaningful. Other schema or statistical methods may be employed by the present invention to determine the significance of the cited patents.

In step 260, the server 106 determines whether there are additional CP's whose citations have not yet been analyzed and whose citation percentiles relative to their peers have not yet been determined. If there are additional CP's, then the “Yes” branch is followed to step 265.

In step 265, the next CP is selected, which now becomes CP(x). The citation percentile of this new CP(x) relative to its peers is then determined by proceeding back to step 240.

Returning again to step 260, if there are no more CP's whose citation percentiles have not been determined, then the “No” branch is followed to step 270. In step 270, the server 106 determines whether the patent application PA has value based on the citation percentiles for its various CP's, CP(1) through CP(n). There are multiple ways to do this analysis. In some embodiments, the patent application PA is considered valuable if even one of its CP's has a high citation percentile. In other embodiments, a certain number or a certain percentage of its CP's must have a high citation percentile for a PA to be considered valuable. Different thresholds can be set for what is considered to be a high citation percentile.

Moreover, in determining whether patent application PA has value, the server 106 may weight the importance of the citation percentile for different CP's differently depending on whether a particular CP was cited by the applicant or by the Examiner for a patent application. The server 106 may consider only CP's cited by applicants, only CP's cited by an Examiner, or some combination of both. Server 106 may also weight CP's differently depending on the year of issue of the CP, technology classification of the CP, or other criteria, such as the assignee of the cited patent, the inventor of the cited patent, etc.

While the patent citations to the CP's are normalized in a specific way in step 250, one skilled in the art will recognize alternative methods for normalizing the number of citations to a patent. Moreover, in some embodiments of the present invention, the number of citations to the CP's are not normalized at all. In such embodiments, the patent application PA may be considered to be valuable in step 270 if any one of the CP's has at least a threshold number of citations to it from other patents, if a certain percentage of the CP's each has a threshold number of citations to it from other patents, and/or if all the CP's together have at least a threshold number of citations to them cumulatively. Based on the underlying theory that a patent application PA is valuable if the patents CP(1) through CP(n) cited against it during prosecution are highly cited, other ways of determining the value of PA in step 270 by assessing the citations to the cited patents CP(1) through CP(n) will occur to those skilled in the art.

In step 280, the value of the patent application PA has been assessed. The server 106 may then provide this value assessment to the subscriber 100 who requested this analysis. Server 106 may provide the value assessment in a variety of formats and/or reports known to those skilled in the art.

The method disclosed in FIG. 2 involves valuing a patent application based on patents cited against it by a specific point in time. But as prosecution proceeds, additional IDS's may be filed and additional Office Actions sent by the Examiner, each potentially resulting in the citation of new patents against patent application PA. These newly cited patents, in turn, may better inform an analysis of the true value of PA using the citation analysis of the present invention. Thus, the server 106 may monitor an application and periodically repeat the analysis of FIG. 2 when new patents are cited against the patent application PA during its prosecution. Again, subscribers 100 may request such a monitoring, or server 106 may be configured to automatically refresh its analysis to subscriber 100 at some default interval or at an interval requested by subscriber 100.

Server 106 may select which patent applications it monitors based on a variety of criteria. For example, server 106 may simply receive a request from subscribers 100 for one or more patent applications. Alternatively, server 106 may automatically monitor patent applications based on a particular date range, technology class, one or more inventors, or one or more assignees. One skilled in the art will recognize that server 106 may be configured to select patent applications for monitoring in a wide variety of ways.

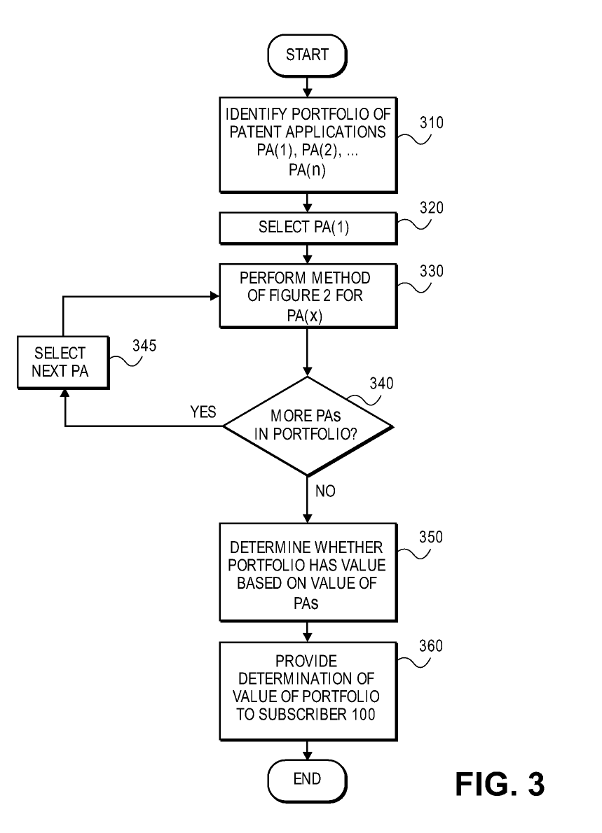

The present invention may be extended from analysis of a single patent application to the analysis and valuation of a group of patent applications. FIG. 3 is a flow chart illustrating an exemplary process for doing so. As with the process for analyzing a single patent application, server 106 may implement this process by programming or configuring it with the appropriate logic and software.

The method of FIG. 3 starts at step 310. In that step, the server 106 identifies a set or portfolio of patent applications to evaluate. For convenience of explanation, these patent applications will be denoted PA(1), PA(2), . . . PA(n), where n>=1.

The decision of the server 106 to evaluate a particular set of patents may result from a request from one of the subscribers 100. While the subscriber 100 could explicitly identify the set of patent applications to evaluate, subscriber 100 may alternatively specify that the server 106 evaluate all patent applications meeting certain criteria, such as all patents applications containing a specified keyword, all patent applications belonging to a specified assignee, all applications having a certain inventor or group of inventors, all applications publishing within a certain date range, and/or the like. The subscriber 100 could also specify the set to include all applications meeting some combination of such criteria. Alternatively, the server 106 may be configured to automatically evaluate various portfolios of patent applications based on criteria provided by a system administrator or service operating server 106. Indeed, server 106 may analyze any group or portfolio of patent applications.

Each of the patent applications of the identified set or portfolio, denoted generically as PA(x), is now evaluated in turn by server 106. In step 320, server 106 selects for processing the first of the patent applications, PA(1).

In step 330, server 106 evaluates patent application PA(x) using the method described in FIG. 2, with PA(x) serving as the identified patent application in step 210 of FIG. 2. In step 280 of FIG. 2, the result of the analysis of patent application PA(x) is stored by server 106 so that it can further process the result once it has accumulated the results of analyzing the other PA's in the portfolio under analysis. The determination of the individual value of PA(x) may be provided to subscriber 100 at this time, but it need not be.

In step 340, the server 106 determines whether there are additional PA's in the portfolio that it has not yet analyzed. If there are additional PA's, then the “Yes” branch is followed to step 345. In step 345, the next PA is selected, which now becomes PA(x), and the value of this patent application is determined by proceeding back to step 330.

Returning again to step 340, if there are no more PA's to be evaluated in the portfolio, then the “No” branch is followed to step 350. In step 350, the server 106 determines whether the portfolio of patent applications PA(1), PA(2), . . . PA(n) has value as a whole based on the value of each of the individual PA's in the portfolio. There are multiple ways to do this analysis. In some embodiments, the portfolio may be considered valuable if even one of its PA's is valuable. In other embodiments, a certain number or a certain percentage of its PA's must be valuable for the portfolio as a whole to be considered valuable. In some embodiments, the analysis of FIG. 2 on each individual patent application PA in the portfolio yields a valuation that falls on a sliding scale, and the server 106 concludes that the portfolio as a whole has value only if a certain percentage of the individual PA's in the portfolio have at least a threshold value.

Moreover, in determining whether a portfolio as a whole has value, the server 106 may weight the importance of different PA's in the portfolio differently depending on various characteristics of each PA, such as its publication or filing date, technology class, inventorship, assignee, and/or the like.

Other factors may also influence how valuable a given patent-application portfolio is relative to other application portfolios. For example, server 106 may consider the overall number of patent applications in the portfolio, the number or percentage of patent applications in the portfolio that are valuable, the owner of the applications in the portfolio (if a common owner), trends in the number of applications filed by the company that owns the portfolio or the technology classes in which that company is filing applications, average product life for the company or companies owning the applications, average product life for companies in the same industry as the owner of the application portfolio, the number of citations in non-patent literature to the technology of the company owning the applications, and so on. These kinds of factors may be especially significant in comparing investments in two or more different companies based on the value of their patent portfolios or, when considering an investment in a single company, determining how much weight to place on the analysis of its patent portfolio versus how much weight to place on traditional investment metrics known to those skilled in the art of investing.

In step 360, the value of the patent portfolio has been assessed. The server 106 may then provide this value assessment to the subscriber 100 who requested this analysis. Server 106 may provide the value assessment in a variety of formats and/or reports known to those skilled in the art. The server 106 may also at any time during the process provide the individual value assessments of each patent application PA(x) in the portfolio.

Of note, the server 106 may monitor a portfolio and periodically repeat the analysis of FIG. 3 as new patents are cited against the patent applications that make up that portfolio during the prosecution of those patent applications. Again, this may occur at the request of subscribers 100 or because server 106 is programmed to do so automatically.

The present invention may be further extended from analysis of a portfolio of patent applications to the analysis and valuation of one or more companies to inform an investment decision in stock of those companies by a subscriber 100, a mutual fund, or another financial instrument. The stock of each of these companies is evaluated at least in part on the basis of whether its portfolio of patent applications suggests that the company owns technological advances that the market has not yet appreciated. A ranking of the selected companies based on prospects for stock appreciation can also be provided.

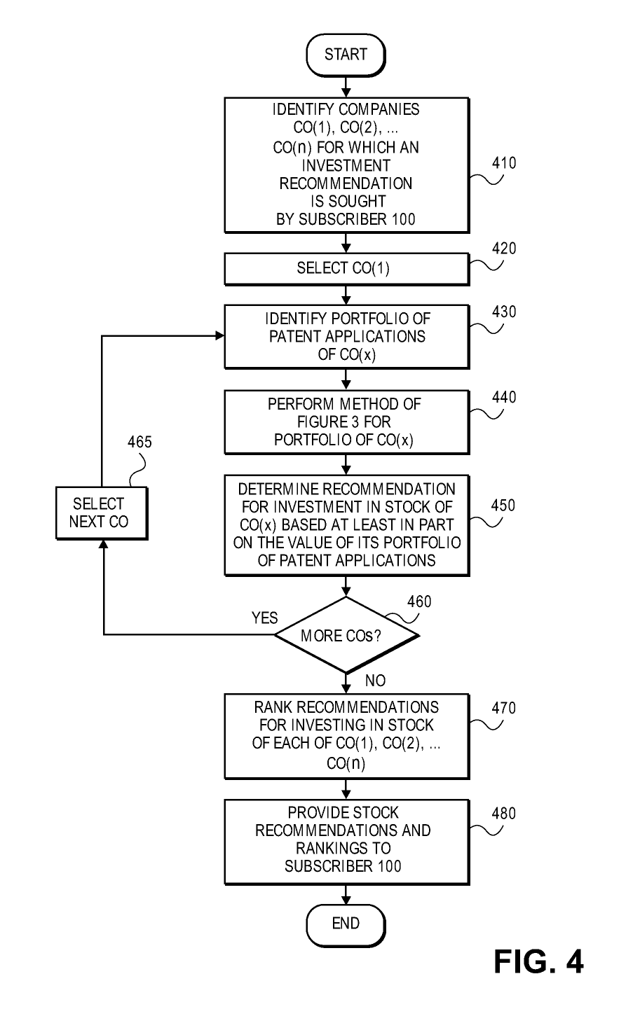

FIG. 4 illustrates an exemplary process for performing the described analysis of whether to invest in the selected group of companies. As with the process for analyzing a portfolio of patent applications, server 106 may implement this process by programming or configuring it with the appropriate logic or software.

The method of FIG. 4 starts at step 410. In that step, the server 106 identifies those companies for which an investment recommendation is sought by the subscriber 100. For convenience of explanation, these companies will be denoted CO(1), CO(2), . . . CO(n), where n>=1.

The decision of the server 106 to evaluate a particular set of companies may result from a request from one of the subscribers 100. Although the subscriber 100 may explicitly identify the set of companies to evaluate, the subscriber 100 may alternatively specify that the server 106 evaluate all companies meeting certain criteria, such as all companies in a particular industry, all companies selling certain types of technology, all companies having a specified market capitalization, all companies having a certain number of employees, and/or the like. The subscriber could likewise instruct the server 106 to examine all companies meeting any combination of such criteria. In yet another alternative embodiment, the server 106 may be configured to automatically select companies for evaluation based on criteria provided by a system administrator, mutual fund, or other financial instrument with access to server 106. The companies to be evaluated using the methods of the present invention may optionally first be filtered based on investment metrics known to those skilled in the art of investing. For example, the companies may be filtered based on stock price, earnings, price-to-earnings ratio, market capitalization, and/or some combination of these criteria.

Each of the companies to be examined, denoted generically as CO(x), is now evaluated in turn by server 106. In step 420, server 106 selects for processing the first of the companies, CO(1).

In step 430, the server 106 identifies the portfolio of patent applications of company CO(x). For example, server 106 may query database 110 and/or patent information sources 104 for this information. As noted, database 110 may comprise various data structures and tables to accurately track when a given company has control over patent applications that have different assignee names. Such data can help to more fully identify the complete portfolio of patent applications for company CO(x).

In step 440, the server 106 evaluates the portfolio of patent applications of CO(x) as described in FIG. 3, with this portfolio serving as the identified patent portfolio in step 310 of FIG. 3. In step 360 of FIG. 3, the result of the analysis of the portfolio of patent applications owned by CO(x) is stored by server 106 so that it can further evaluate an investment in stock of CO(x). The determination of the value of CO(x)'s portfolio of patent applications may be provided to subscriber 100 at this time, but it need not be. Preferably, the “value” used to describe the strength of the portfolio permits comparison to the strength of the application portfolios of other companies, but that need not be the case.

In step 450, server 106 determines whether and how strongly to recommend investing in the stock of CO(x) based at least in part on the value of its patent-application portfolio. The higher the valuation of CO(x)'s application portfolio using the method of FIG. 3, the stronger the recommendation for investing in the stock of CO(x), ignoring other investment metrics. Again, the theory for providing a higher investment recommendation for stock in a company with a more valuable patent-application portfolio is because the technological advances underlying an application portfolio identified as more valuable according to the methods of the present invention have typically not yet been commercialized and therefore appreciated by the market.

In deciding whether and how strongly to recommend investing in CO(x), the server 106 may use the value of CO(x)'s patent-application portfolio as but one factor, the other factors being the attractiveness of an investment in CO(x) according to traditional methods known to those skilled in the art for evaluating a potential investment in a company or its stock. The server 106 may obtain the information and metrics for such traditional investment analysis from financial information sources 102 and even perform that analysis itself.

The server 106 then stores in database 110 its analysis of whether and how strongly to recommend an investment in the stock of CO(x). It may provide this analysis to subscriber 100 at this time, but it need not do so.

In step 460, the server 106 determines whether there are additional companies that have not yet been analyzed. If there are additional CO's, then the “Yes” branch is followed to step 465.

In step 465, the next company CO is selected, which now becomes CO(x), and an investment in this company is evaluated by proceeding back to step 430.

Returning again to step 460, if there are no more companies for which an investment recommendation has been sought, then the “No” branch is followed to step 470.

In step 470, the server 106 ranks its recommendations for investing in the stock of companies CO(1), CO(2), . . . , CO(n). This is possible in those embodiments of the present invention where the server 106 performs enough analysis to determine how strongly to recommend or not recommend investment in each company. Even if this ranking step is not done, however, the server 106 may still provide a useful service to users by providing a simple “yes” or “no” recommendation for investing in each company.

In step 480, the server 106 may then provide its stock recommendations and rankings (if calculated) to the subscriber 100 (or to the mutual fund manager, in embodiments where that is the user of the services of server 106). Server 106 may provide this information in a variety of formats and/or reports known to those skilled in the art.

Of note, the server 106 may monitor one or more of the companies and periodically repeat the analysis of FIG. 4. Again, subscribers 100 may request such a monitoring, or server 106 may be configured to automatically refresh its analysis at some default or requested interval.

Server 106 may select which companies it monitors based on a variety of criteria. For example, server 106 may simply receive a request to do so from subscribers 100 for one or more of the companies. Alternatively, server 106 may automatically monitor certain companies more frequently, such as those that tend to file more patent applications or those companies in certain technologies.

In yet another embodiment, only those companies in which a subscriber 100 has invested may be monitored. A decrease in the value of the portfolio of patent applications of one of the companies may then trigger a sell decision for stock in that company.

Likewise, the server 106 may monitor as a group the patent-application portfolios of those companies in which the subscriber 100 has not yet invested, with a later increase in the value of the patent-application portfolios of those companies leading to a buy decision for stock in those companies. One skilled in the art will recognize that server 106 may be configured to monitor various companies in a wide variety of ways.

Other embodiments of the present invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for determining a value of a patent application, comprising:
identifying a set of one or more patents cited against the patent application during prosecution of the patent application;
for each cited patent in the set, determining a number of citations to the cited patent by other patents; and
determining the value of the patent application based at least in part on the number of citations to the cited patents in the set.

2. The method of claim 1, wherein identifying the set of one or more cited patents comprises:
accessing prosecution-history documents through the U.S. Patent & Trademark Office's Patent Application Information Retrieval Service; and
identifying patents cited in the prosecution-history documents.

3. The method of claim 1, wherein the set of cited patents comprises only patents cited by or on behalf of an applicant associated with the patent application.

4. The method of claim 1, wherein the set of cited patents comprises only patents cited by a person responsible for examining whether to issue a patent based on the patent application.

5. The method of claim 1, wherein the set of cited patents comprises at least one patent cited by or on behalf of an applicant associated with the patent application and at least one patent cited by a person responsible for examining whether to issue a patent based on the patent application.

6. The method of claim 1, wherein determining the value of the patent application based at least in part on the number of citations to the cited patents in the set comprises determining that the patent application has high value where at least one of the cited patents in the set has at least a threshold number of citations.

7. The method of claim 1, wherein determining the value of the patent application based at least in part on the number of citations to the cited patents in the set comprises determining that the patent application has high value where each of at least a predetermined percentage of the cited patents in the set has at least a threshold number of citations.

8. The method of claim 1, wherein determining the value of the patent application based at least in part on the number of citations to the cited patents in the set comprises determining that the patent application has high value where the cited patents in the set cumulatively have a high number of citations.

9. The method of claim 1, further comprising normalizing the number of citations to each cited patent in the set, and wherein determining the value of the patent application comprises determining the value of the patent application using a result from normalizing the number of citations to the cited patents in the set.

10. The method of claim 1, further comprising:
identifying a technology class and issue year for each cited patent in the set; and
calculating a citation percentile for each cited patent in the set relative to other patents in the technology class that issued in the issue year using the number of citations for the cited patent; and
wherein determining the value of the patent application comprises determining the value of the patent application based at least in part on the citation percentiles for the cited patents in the set.

11. The method of claim 1, wherein determining the value of the patent application based at least in part on the number citations to the cited patents in the set comprises determining that the patent application has high value where at least one of the cited patents in the set has a high number of citations relative to other patents that issued in a same year and in a same technology class.

12. The method of claim 1, wherein the value of the patent application comprises a ranking of value relative to other patent applications.

13. The method of claim 1, wherein the value of the patent application comprises a descriptive indication of value.

14. The method of claim 1, further comprising requesting a license from an owner of a patent application having a high value.

15. The method of claim 1, further comprising offering to purchase a patent application having a high value from an owner of the patent application.

16. The method of claim 1, further comprising transmitting over a computer network to a subscriber to a patent-analysis service an indication of the value of the patent application.

17. The method of claim 1, further comprising determining whether stock in the company owning the patent application is undervalued based at least in part on the value of the patent application.

18. The method of claim 1, further comprising:
determining whether to recommend investing in stock of the company owning the patent application based at least in part on the value of the patent application; and
providing a recommendation for the stock over a data network to a subscriber to a stock-recommendation service.

19. A computer-readable medium having computer-executable instructions for performing the method of claim 1.

20. A method for determining whether a company represents an attractive investment, comprising:
identifying a group of patent applications owned by the company;
for each patent application in the group,
identifying a set of one or more patents cited against the patent application during prosecution of the patent application,
for each cited patent in the set, determining a number of citations to the cited patent by other patents, and
determining a value of the patent application based at least in part on the number of citations to the cited patents in the set; and
determining whether the company represents an attractive investment based at least in part on the values of the patent applications in the group.

21. The method of claim 20, wherein the group of patent applications comprises all patent applications owned by the company that are published.

22. The method of claim 20, wherein determining whether the company represents an attractive investment comprises determining that the company represents an attractive investment where at least one patent application in the group has high value.

23. The method of claim 20, wherein determining whether the company represents an attractive investment comprises determining that the company represents an attractive investment where at least a certain percentage of the patent applications in the group have high value.

24. The method of claim 20, wherein determining whether the company represents an attractive investment based at least in part on the values of the patent applications in the group comprises comparing the values of the patent applications to values of patent applications for at least one other company.

25. The method of claim 20, wherein determining the value of the patent application based at least in part on the number of citations to the cited patents in the set comprises normalizing the number of citations to the cited patents.

26. The method of claim 20, further comprising sending over a computer network to a subscriber to a stock-recommendation service a recommendation relating to investing in stock of the company that is based on whether the company represents the attractive investment.

27. A computer-readable medium having computer-executable instructions for performing the method of claim 20.
